(19) United States
(12) Patent Application Publication
(10) Pub. No.: US 2018/0025696 A1
(43) Pub. Date: Jan. 25, 2018

(54) DISPLAY DEVICE AND DATA DRIVER

(71) Applicant: AU Optronics Corporation, Hsin-Chu (TW)

(72) Inventors: Shih-Yuan SU, Hsin-Chu (TW); Kai-Yuan Siao, Hsin-Chu (TW); Jian-Feng Li, Hsin-Chu (TW); Chun-Kuei Wen, Hsin-Chu (TW)

(21) Appl. No.: 15/384,558

(22) Filed: Dec. 20, 2016

(30) Foreign Application Priority Data
Jul. 22, 2016 (TW) 105123238

(51) Int. Cl. G09G 5/00

(52) U.S. Cl. CPC G09G 5/003; G09G 2310/08; G09G 2310/0291; G09G 2310/0275; G09G 2310/0267; G09G 2310/0289

(57) ABSTRACT

A data driver for a display device comprises a first boost circuit, a first gate clock generation circuit, a first level shift circuit, and a data drive circuit. The first boost circuit is used to receive a supply voltage value and generate at least one preset voltage value. The first gate clock generation circuit is electrically coupled to the first boost circuit, and is used to receive a plurality of timing signals and at least one preset voltage value, and generate at least one first timing signal. The first level shift circuit is used to receive the at least one first timing signal and generate at least one gate timing signal. The data drive circuit is used to receive the timing signals, and generate a plurality of display data signals.

### BACKGROUND

### Technical Field

The present invention relates a display device and a data driver thereof, and in particular, a display device suitable for a narrow bezel and a data driver thereof.

### Related Art

With the rapid development of science and technology, the life quality is improved, and consumers have increasingly high requirements on electronic devices, for example, pursuing for a lighter and thinner design, a higher speed, or a better visual effect. One method for improving the visual effect of an electronic device is to increase the display range of the electronic device. However, as the display range is increased, the area occupied by the bezel is reduced, and consequently the area for configuring hardware elements and circuit wirings is reduced, leading to difficulties in design.

### SUMMARY

To achieve the foregoing objective of reducing the bezel in a more convenient manner, the present invention provides an embodiment of a data driver applicable to a display device, the data driver including a first boost circuit, a first gate clock generation circuit, a first level shift circuit, and a data drive circuit, where the first boost circuit is used to receive a supply voltage value, and generate at least one preset voltage value; the first gate clock generation circuit is electrically coupled to the first boost circuit, and is used to receive a plurality of timing signals and the at least one preset voltage value, and generate at least one first timing signal; the first level shift circuit is used to receive the at least one first timing signal and generate at least one first gate timing signal; and the data drive circuit is used to receive the timing signals, and generate a plurality of display data signals.

The present invention further provides a display device, including a power supply circuit, a timing controller, a first data driver, a gate driver, and a plurality of pixel units, where the power supply circuit is used to provide a supply voltage value; the timing controller is used to provide a plurality of timing signals; the first data driver is electrically coupled to the timing controller and the power supply circuit, and is used to receive the plurality of timing signals and the supply voltage value, and generate a plurality of display data signals and a plurality of first gateway timing signals; the gate driver is electrically coupled to the first data driver, and is used to receive the plurality of first gateway timing signals, and generate a plurality of gate driving signals; and the plurality of pixel units are electrically coupled to the first data driver and the gate driver, and are used to determine, according to the corresponding gate driving signals, whether to receive the corresponding display data signals.

Based on the above, because the data driver includes the first boost circuit, the first gate clock generation circuit, the first level shift circuit, and the data drive circuit, the number of elements and the volume of a printed circuit board can be effectively reduced, so that the area of a bezel of the display device can be reduced. In addition, because the timing controller is independent of the data driver, the data driver of the present invention receives timing signals output by a same timing controller, and when a single display device needs to be driven by a plurality of data drivers, the plurality of data drivers can perform operations without requiring any additional synchronization signal. In this way, the wiring space of the printed circuit board is released, thereby greatly facilitating the design of circuit wirings of the display device.

To make the aforementioned and other objectives, features and advantages of the present invention more comprehensible, embodiments accompanied with figures are described in detail below.

### BRIEF DESCRIPTION OF THE DRAWINGS

FIG. 1 is a schematic diagram of an embodiment of a display device of the present invention.

FIG. 2A is a schematic diagram of an embodiment of a data driver of the present invention.

FIG. 2B is a schematic diagram of an embodiment of a level shift circuit of the present invention.

FIG. 3 is a schematic diagram of an embodiment of configuration of a display device of the present invention.

FIG. 4 is a schematic diagram of an embodiment of coupling of a level shift circuit of the present invention.

### DETAILED DESCRIPTION

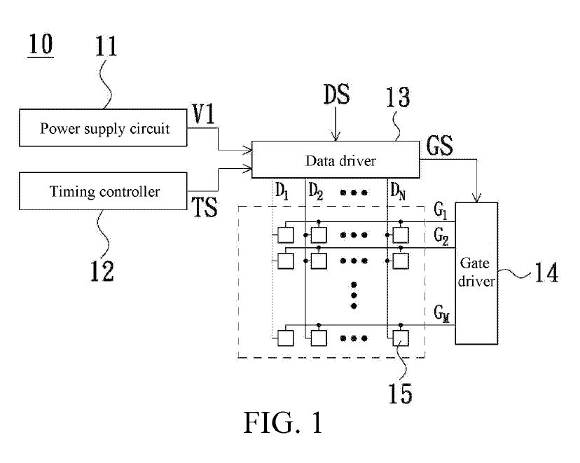

First, referring to FIG. 1, FIG. 1 is a schematic diagram of an embodiment of a display device 10 provided in the present invention. The display device 10 includes a power supply circuit 11, a timing controller 12, a data driver 13, a gate driver 14, and a plurality of pixel units 15. The power supply circuit 11 is used to provide a supply voltage value V1 to the data driver 13. The timing controller 12 is used to provide a plurality of different timing signals TS to the data driver 13. The timing signals TS are, for example, a first clock signal (CLK) and a second clock signal (XCK) with mutually inverted timings. The data driver 13 is electrically coupled to the power supply circuit 11, the timing controller 12, the gate driver 14, and the plurality of pixel units 15. The data driver 13 is used to generate corresponding display data signals D₁, D₂, . . . , D_{N} according to the supply voltage value V1, the plurality of timing signals, and a plurality of pieces of display data information DS received, and transmit the display data signals D₁, D₂, . . . , D_{N} to the corresponding plurality of pixel units 15. In addition, the data driver 13 is further used to generate a plurality of gate timing signals and transmit the gate timing signals to the gate driver 14. The gate driver 14 is used to generate a plurality of gate driving signals according to the received plurality of gate timing signals GS, and transmit the plurality of gate driving signals to corresponding gate lines, so that the pixel units 15 electrically coupled to the gate lines determine, according to the gate driving signals, whether to receive and display one of the display data signals D₁, D₂, . . . , D_{N}.

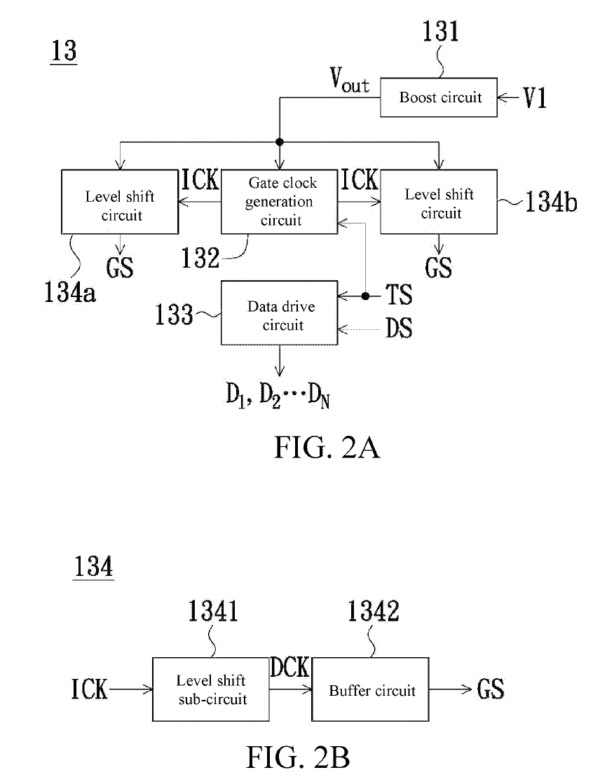

Next, referring to FIG. 2A, FIG. 2A is a schematic diagram of an embodiment of a data driver 13 of the present invention. In this embodiment, the data driver 13 includes a boost circuit 131, a gate clock generation circuit 132, a data drive circuit 133, a first level shift circuit 134, and a second level shift circuit 134b. The boost circuit 131 is used to receive the supply voltage value V1, and generate a plurality of preset voltage values Vₒᵤₜ according to the supply voltage value V1. The preset voltage values Vₒᵤₜ are, for example, a high voltage level and a low voltage level. The gate clock generation circuit 132 is electrically coupled to the boost circuit 131, and the gate clock generation circuit 132 is used to receive the preset voltage values Vₒᵤₜ and the timing signals TS, and generate a plurality of initial timing signals ICK with different timings according to the preset voltage values Vₒᵤₜ and the timing signals TS, for example, a plurality of successive first timing signals ICK₁, ICK₂, . . . , ICK_{L}, where L is a positive integer greater than zero. The data drive circuit 133 is used to receive the plurality of pieces of display data information DS and the timing signals TS, and generate the display data signals D₁, D₂, . . . , D_{N} according to the display data information DS and the timing signals TS, where N is a positive integer greater than zero. The data drive circuit 133 transmits the display data signals D₁, D₂, . . . , D_{N} to the corresponding plurality of pixel units 15. The level shift circuit 134a is electrically coupled to the boost circuit 131 and the gate clock generation circuit 132. The level shift circuit 134a is used to receive the preset voltage values Vₒᵤₜ and the plurality of initial timing signals ICK, and perform level adjustment to generate a plurality of first gate drive timing signals, that is, the foregoing gate timing signals GS, for example, a plurality of gate clock signals CLK₁, CLK₂, . . . , CKL_{M}, where M is a positive integer greater than zero. The level shift circuit 134a transmits the plurality of first gate drive timing signals to the gate driver 14, so that the gate driver 14 generates a corresponding plurality of gate driving signals according to the plurality of gate drive timing signals. The second level shift circuit 134b is electrically coupled to the gate clock generation circuit 132, and is used to receive the initial timing signals ICK, for example, a second timing signal having a timing different from that of the first timing signal, and generate a plurality of second gate drive timing signals according to the initial timing signals ICK. Therefore, in this embodiment, the gate driver 14 generates a corresponding plurality of gate driving signals according to the first gate drive timing signals and the second gate drive timing signals. For example, the first gate drive timing signals are used to generate gate driving signals of odd-numbered rows of gate lines, and the second gate drive timing signals are used to generate gate driving signals of even-numbered rows of gate lines, but the present invention is not limited thereto. In other embodiments, the level shift circuit 134a and the level shift circuit 134b may be configured on opposite sides, that is, may be configured on the left and right sides of the data driver 13.

Referring to FIG. 2B, FIG. 2B is a schematic diagram of an embodiment of the level shift circuit 134. The level shift circuit 134 may include a level shift sub-circuit 1341 and a buffer circuit 1342. The level shift sub-circuit 1341 is used to adjust levels of received initial timing signals ICK according to requirements and output adjusted clock signals DCK obtained after the adjustment. After receiving the adjusted clock signals DCK, the buffer circuit 1342 buffers the plurality of adjusted clock signals DCK and then outputs the adjusted clock signals DCK as the gate timing signals GS. Therefore the output plurality of gate timing signals GS are non-overlapping with each other, that is, ON periods of the plurality of gate timing signals GS are non-overlapping. For example, periods in which the plurality of gate timing signals GS are at a logical high level are non-overlapping with each other.

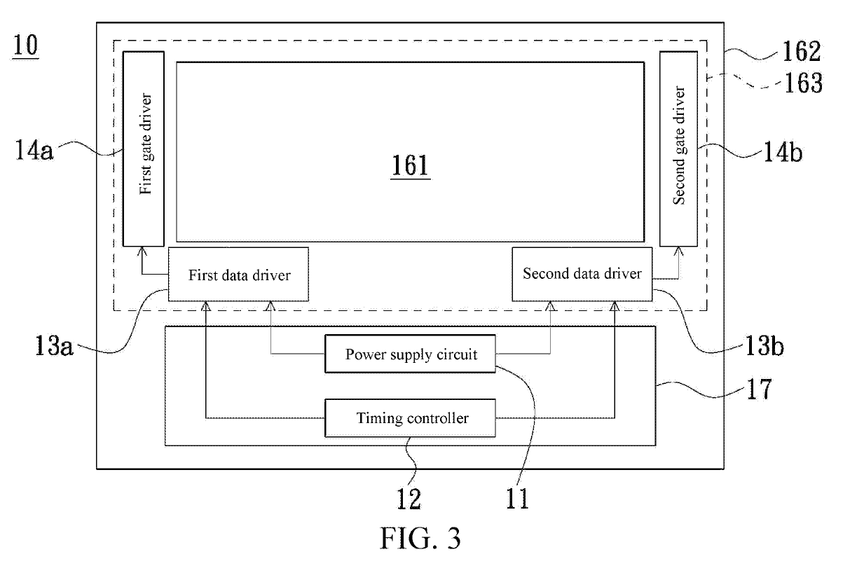

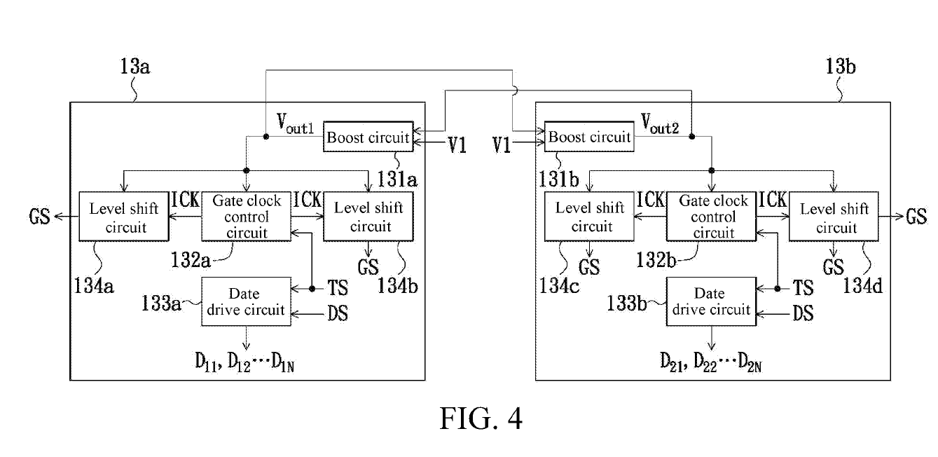

Next, referring to FIG. 3 and FIG. 4, FIG. 3 is a schematic diagram of an embodiment of configuration of the display device 10, and FIG. 4 shows an embodiment of configuration of the data driver. The display device 10 includes a display area 161 for display and a bezel area 162. The plurality of pixel units 15 is configured on a substrate 163 of the display device 10 and a user can watch a displayed image by using the display area 161. The power supply circuit 11, the timing controller 12, the data driver 13, and the gate driver 14 may be configured in the bezel area 162. In this embodiment, the display device 10 may include two data drivers 13 and two gate drivers 14, that is, a first data driver 13a, a second data driver 13b, a first gate driver 14a, and a second gate driver 14b as shown in FIG. 3. The first data driver 13a, the second data driver 13b, the first gate driver 14a, and the second gate driver 14b are configured on the substrate 163, and the first data driver 13a and the second data driver 13b may be individually configured on the left and right sides of the display device 10, and respectively electrically coupled to the first gate driver 14a and the second gate driver 14b. In this embodiment, the first gate driver 14a may be used to drive odd-numbered rows of gate lines, and the second gate driver 14b may be used to drive even-numbered rows of gate lines, but the present invention is not limited thereto. The user may configure gate lines that need to be driven by the first gate driver 14a and the second gate driver 14b according to requirements. According to the foregoing content, because the level shift circuit 134 has been integrated into the data driver 13, and the data driver 13 can be configured on the substrate 163 of the pixel unit 15, the wiring distance between the level shift circuit 134 and the gate driver 14 is effectively reduced. In this way, not only the wiring space is saved, but also a short wiring distance can effectively alleviate signal attenuation or distortion. Moreover, in this embodiment, only the power supply circuit 11 and the timing controller 12 are configured on a printed circuit board 17, and therefore the volume needed by the printed circuit board 17 is greatly reduced. The power supply circuit 11 and the timing controller 12 are electrically coupled to the first data driver 13a and second data driver 13b by the printed circuit board 17. Because timing signals TS needed by the first data driver 13a and the second data driver 13b are both provided by the timing controller 12, although the first data driver 13a and the second data driver 13b are used to drive different gate lines, no additional synchronization signal is needed to keep synchronization between them. The timing signals TS provided by the timing controller 12 enable the first data driver 13a and the second data driver 13b to correctly output a corresponding plurality of initial timing signals ICK according to the required timing, so that the first gate driver 14a and the second gate driver 14b can correctly generate corresponding gate control signals to control the plurality of pixel units 15 to display. Therefore, the present invention can further release the wiring space of the printed circuit board 17. Further, according to the foregoing other embodiments, as shown in FIG. 2A, each data driver 13 may further include two level shift circuits 134. Therefore, the first data driver 13a not only includes a boost circuit 131a, a gate clock generation circuit 132a, a data drive circuit 133a, and a level shift circuit 134a, but also further includes a level shift circuit 134b, where the data drive circuit 133a is used to output a plurality of display data signals D₁₁, D₁₂ . . . D_{1N}, and the boost circuit 131a is used to output a first voltage value Vₒᵤₜ₁; the second data driver 13b not only includes a boost circuit 131b, a gate clock generation circuit 132b, a data drive circuit 133b, and a level shift circuit 134c, but also further includes a level shift circuit 134d, where the data drive circuit 133b is used to output a plurality of display data signals D₂₁, D₂₂ . . . D_{2N}, and the boost voltage 131b is used to output a second voltage value Vₒᵤₜ₂, as shown in FIG. 4. Therefore, the user can determine, according to requirements, whether the data driver 13 synchronously uses two level shift circuits 134. That is, in some embodiments, the first data driver 13a and the second data driver 13b can drive all the pixel units 15 by using only one level shift circuit 134, or a single data driver 13 drives all the pixel units 15 by using two level shift circuits 134, for example, the level shift circuits 134a and 134b. In other embodiments, if the display device 10 has a large number of pixel units 15, the first data driver 13a and the second data driver 13b need to use all the level shift circuits 134 to drive the pixel units 15. When two level shift circuits 134 of two data drivers 13 need to be used for the number of pixel units 15, the level shift circuit 134a and the level shift circuit 134d can be individually electrically coupled to the first gate driver 14a and the second gate driver 14b by directly using the substrate 163 because the level shift circuit 134a and the level shift circuit 134d are configured on the left side of the first data driver 13a and on the right side of the second data driver 13b. In addition, because no synchronization is required between the first data driver 13a and the second data driver 13b and the wiring space on the printed circuit board 17 is released, and the level shift circuit 134b and the level shift circuit 134c are configured on the right side of the first data driver 13a and on the left side of the second data driver 13b, the level shift circuit 134b and the level shift circuit 134c can be electrically coupled to the gate driver 14 with a minimum wiring distance by using the wiring space released by the printed circuit board 17, so that the driving capability of the first data driver 13a and the second data driver 13b can be improved without increasing the area of the bezel area 162.

In the embodiment of the display device 10 in FIG. 4, the display device 10 includes the first data driver 13a and the second data driver 13b, so that the display device 10 has a good pixel driving capability. An output end of the boost circuit 131b of the second data driver 13b may be electrically coupled to an input end of the boost circuit 131a of the first data driver 13a, and an output end of the boost circuit 131a of the first data driver 13a may be electrically coupled to an input end of the boost circuit 131b of the second data driver 13b. Because the first data driver 13a and the second data driver 13b are used to drive different gate lines, and the gate lines are individually driven, only one boost circuit 131 is used to drive the gate lines at a time. When one of the boost circuit 131b and the boost circuit 131a needs to output the first voltage value Vₒᵤₜ₁ or the second voltage value Vₒᵤₜ₂ to drive the gate lines, to avoid the occurrence of under-voltages or severe voltage ripples occur in the boost circuit 131 due to an excessively large drawn current of the pixel units 15 when the gate lines are driven, taking the use of the boost circuit 131a to drive the gate lines as an example, the boost circuit 131b may output the second voltage value Vₒᵤₜ₂ as an input to the boost circuit 131a. When the pixel units 15 are driven, the second voltage value Vₒᵤₜ₂ output by the boost circuit 131b not only can increase the voltage driving capability of the first voltage value Vₒᵤₜ₁, but also can compensate for the first voltage value Vₒᵤₜ₁ in time when the pixel units 15 are driven, so as to avoid the occurrence of under-voltages or severe voltage ripples. In addition, because two boost circuits, that is, the boost circuit 131a and the boost circuit 131b, are used to share the burden of outputting a voltage value, the occurrence of over-temperature in the case where a single data driver 13 is used to drive the pixel units 15 can be effectively avoided.

In conclusion, because the data driver 13 of the present invention further includes the boost circuit 131, the gate clock generation circuit 132, and the level shift circuit 134 in addition to the data drive circuit 133, the volume of the printed circuit board 17 is effectively reduced. In addition, because the data driver 13 can be electrically coupled to the gate driver 14 without using wirings of the printed circuit board 17, not only the wiring distance can be reduced, but also signal attenuation can be alleviated. Further, because a plurality of data drivers 13 receive timing signals generated by a same timing controller 12, that is, the plurality of data drivers 13 can achieve an effect of clock synchronization by using the timing controller 12, no additional synchronization signal needs to be electrically coupled between the plurality of data drivers 13, so that the wiring space of the printed circuit board 17 can be released more effectively. Therefore, by means of the released wiring space and the plurality of level shift circuits 134, the pixel driving capability of the display device is further improved. Moreover, because the boost circuit 131a of the first data driver 13a is electrically coupled to the boost circuit 131b of the second data driver 13b, the boost circuit 131a may output the first voltage value Vₒᵤₜ₁ as an input to the boost circuit 131b, and the boost circuit 131b may output the second voltage value Vₒᵤₜ₂ as an input to the boost circuit 131a, the voltage value Vₒᵤₜ output by one boost circuit 131 can be used to assist in stabilizing the preset voltage value Vₒᵤₜ output by the other boost circuit 131. When an element draws a voltage, the assisting preset voltage value Vₒᵤₜ is used to compensate for the drawn preset voltage value Vₒᵤₜ, so as to avoid the occurrence of under-voltages or severe voltage ripples in the boost circuit 131 of a single data driver 13 due to an excessively large drawn current. Furthermore, using more than one boost circuit 131 to share the burden of outputting a voltage value can further effectively avoid the occurrence of over-temperature in the case where a single data driver 13 is used.

The present invention is disclosed through the foregoing embodiments; however, these embodiments are not intended to limit the present invention. Various changes and modifications made by persons of ordinary skill in the art without departing from the spirit and scope of the present invention shall fall within the protection scope of the present invention. The protection scope of the present invention is subject to the appended claims.

What is claimed is:

1. A data driver applicable to a display device, comprising:
a first boost circuit, receiving a supply voltage value and generating a preset voltage value;
a first gate clock generation circuit, electrically coupled to the first boost circuit, receiving a plurality of timing signals and the preset voltage value, and generating a first timing signal;
a first level shift circuit, receiving a first timing signal and generating a first gate timing signal; and
a data drive circuit, receiving the plurality of timing signals and generating a plurality of display data signals.

2. The data driver according to claim 1, wherein the first boost circuit is electrically coupled to a second boost circuit of a second data driver.

3. The data driver according to claim 1, wherein the first gate clock generation circuit generates a second timing signal.

4. The data driver according to claim 3, wherein the data driver comprises a second level shift circuit, receiving the second timing signal and generating a second gate timing signal, wherein the first level shift circuit is on a first side of the data driver, the second level shift circuit is on a second side of the data driver, and the first side is opposite to the second side.

5. A display device, comprising:
a power supply circuit, for providing a supply voltage value;
a timing controller, for providing a plurality of timing signals;
a first data driver, electrically coupled to the timing controller and the power supply circuit, receiving the plurality of timing signals and the supply voltage value, and generating a plurality of display data signals and a plurality of first gateway timing signals;
a gate driver, electrically coupled to the first data driver, receiving the first gateway timing signals, and generating a plurality of gate driving signals; and
a plurality of pixel units, electrically coupled to the first data driver and the gate driver, receiving the display data signals according to the gate driving signals.

6. The display device according to claim 5, wherein the first data driver further comprises:
a first boost circuit, receiving the supply voltage value and generating a preset voltage value;
a first gate clock generation circuit, electrically coupled to the first boost circuit, receiving the plurality of timing signals and the preset voltage value, generating a first timing signal;
a first level shift circuit, receiving the first timing signal and generating a first gateway timing signal; and
a data drive circuit, receiving the plurality of timing signals and generating the display data signals.

7. The display device according to claim 6, wherein the first boost circuit is electrically coupled to a second boost circuit of a second data driver.

8. The display device according to claim 6, wherein the first gate clock generation circuit generates a second timing signal.

9. The display device according to claim 8, wherein the first data driver comprises a second level shift circuit, receiving the second timing signal and generating a second gate timing signal, wherein the first level shift circuit is on a first side of the first data driver, the second level shift circuit is on a second side of the first data driver, and the first side is opposite to the second side.

10. The display device according to claim 5, wherein the power supply circuit and the timing controller are on a printed circuit board.
